(19) United States
(12) Patent Application Publication
(10) Pub. No.: US 2017/0316478 A1
(43) Pub. Date: Nov. 2, 2017

(54) METHODS AND SYSTEMS FOR TRADING ITEMS OVER A NETWORK

(71) Applicant: Park Carroll Hammonf, San Jose, CA (US)

(72) Inventor: Mark Carroll Hammond, San Jose, CA (US)

(73) Assignee: Mark Carroll Hammond, San Jose, CA (US)

(21) Appl. No.: 15/517,955

(22) PCT Filed: Sep. 12, 2015
(86) PCT No.: PCT/US2015/049847

§ 371 Date: Apr. 8, 2017

Related U.S. Application Data
(60) Provisional application No. 62/065,012, filed on Oct. 17, 2014.

(51) Int. Cl. G06Q 30/06; G06Q 40/04; G06Q 30/08

(52) U.S. Cl. CPC G06Q 30/0605; G06Q 30/08; G06Q 40/04

(57) ABSTRACT

A method that includes receiving a request to access an account by a first user, receiving a request to add an item to the first user account, and displaying at least one of a plurality of items in the first user account for a public offer, is provided. The method also includes receiving an offer for the at least one item from a second user, the offer including an exchange request for a second user item, notifying the first user of the offer received, receiving a rating assigned to the second user offer by the first user, and displaying the second user offer and the first user rating publicly. Further, the method includes receiving a response to the second user offer by the first user, and notifying other users that the at least one item is no longer available when the first user accepts the second user offer. A mobile computer device and a computer device configured to perform the above method are also provided.

### CROSS-REFERENCE TO RELATED APPLICATIONS

The present disclosure is a US National Phase Application of International Application No. PCT/US2015/049847, filed on Sep. 12, 2015, entitled “METHODS AND SYSTEMS FOR TRADING ITEMS OVER A NETWORK” by Mark Hammond, which claims priority and is related to US Provisional Patent Application No. 62/065012, filed on Oct. 17, 2014, entitled “METHODS AND SYSTEMS FOR TRADING ITEMS OVER A NETWORK” by Mark Hammond, the contents of which are included herein by reference in their entirety for all purposes.

### BACKGROUND

### Field

The present disclosure relates to methods and systems for trading items over a network. More specifically, the present disclosure relates to methods and systems to facilitate exchange and barter of items and services between users across different geographical locations.

### Background

There is a growing demand of users for trading items without the need to use a financial institution or the disbursement of money. This is especially true for users that may live in different geographical locations. In some situations, a user may have a large and unique collection of items. The user may find it desirable to trade a portion of the collection for other desirable items. While the Internet and mobile networking devices enable users to communicate with remote potential partners in a transaction and find desirable items for users, existing methods and systems require users to disburse money before any transaction is complete. These approaches introduce an intermediate step typically involving a third party such as a financial institution (a Bank, a credit card company, or a private account manager). In addition to the extra level of complexity, these methods introduce an element of risk for important personal and financial user data breach.

Other approaches include the use of social networks where users can communicate one-on-one and exchange items and services. Some attempts to address the shortcomings listed above include advertisements on websites specially devoted to postings. Several websites offer services to facilitate bartering. Websites such as ‘CraigsList’ offer users the ability to barter for items but it is done through email. Other internet services offer users the option of adding items for trade and of making trading offers. However, these services typically prevent users from viewing all offers on a particular item. And most Internet services involved in trading require a dollar value be placed on each item. Requiring a dollar value for Internet trade of items is problematic for several reasons: users outside the United States (U.S.) might not easily know the dollar value of their goods, hand made goods might not have an easily assigned dollar value. Also, manufactured goods might have a manufacturer's suggested retail price (MSRP) that is quite different from what someone is willing to pay for a used version on an internet provider such as Amazon or EBAY.

However, in these approaches the trade happens within a reduced circle of users (typically two, or a few more) providing little visibility to the items for trade.

### SUMMARY

A method as disclosed herein includes receiving a request to access an account by a first user, receiving a request to add an item to the first user account, and displaying at least one of a plurality of items in the first user account for a public offer. The method also includes receiving an offer for the at least one item from a second user, the offer including an exchange request for a second user item, notifying the first user of the offer received, receiving a rating assigned to the second user offer by the first user, and displaying the second user offer and the first user rating publicly. Further, the method includes receiving a response to the second user offer by the first user, and notifying other users that the at least one item is no longer available when the first user accepts the second user offer.

A mobile computer device in some embodiments includes a wireless networking circuit configured to communicate with a remote network server, a memory circuit storing commands, and a processor circuit configured to execute the commands. When the processor circuit executes the commands, it causes the mobile computer device to: request access to a personal account in the network server, request to add a first item for trade into the personal account, and offer the first item to a second user in exchange of a second item in a second user account. The mobile computer device also includes a global positioning system (GP) circuit, configured to provide a geo-coordinate of the mobile device location to the network server.

In some embodiments, a method includes displaying a plurality of items for trade, the items belonging to at least a first user and a second user willing to trade the items and communicating an offer and a counter offer for a subset of the plurality of items for trade between the first user and the second user. The method also includes communicating to a third user that the subset of the plurality of items for trade is no longer available, receiving a selection for a shipping method from the first user and the second user, confirming a receipt of the subset of the plurality of items at a third party storage location, and requesting feedback from the first user and the second user when at least one of a tolerance period has lapsed, or the first user and the second user have received their desired items.

In some embodiments, a non-transitory, computer readable medium stores instructions which, when executed by a processor in a computer, cause the computer to perform a method including displaying a plurality of items in a first user account for a public offer. The method includes receiving an offer for at least one item from the plurality of items in the first user account from a second user, the offer comprising an exchange request for a second item in a second user account, and displaying the second user offer and a first user rating of the second user offer, publicly. The method also includes receiving a response to the second user offer by the first user, and notifying other users that the at least one item is no longer available when the first user accepts the second user offer.

A computer device according to some embodiments includes a memory circuit storing commands, a networking circuit, and a processor circuit configured to execute the commands. When the processor executes the commands it causes the computer to perform the steps of: providing a user of a mobile computer device access to a first user account, and receiving from the user a request to include an item in the first user account. The processor also causes the computer to perform the step of displaying the item for trade in a network of user accounts, providing an offer for the item to the first user from a second user, and notifying other users that the item is no longer available when the first user accepts the offer from the second user.

### BRIEF DESCRIPTION OF THE DRAWINGS

FIG. 1 illustrates a system for trading items over a network, according to some embodiments.

FIG. 2 illustrates a network server for managing a user account in a system for trading items over a network, according to some embodiments.

FIG. 3 illustrates a mobile device for communicating with a network server in a system for trading items over a network, according to some embodiments.

FIG. 4 illustrates a display of a user account in a system for trading items over a network, according to some embodiments.

FIG. 5 illustrates a display for shipping and delivery of items in a method for trading items over a network, according to some embodiments.

FIG. 6 illustrates a flow chart including steps in a method for trading items over a network, according to some embodiments.

FIG. 7 illustrates a flow chart including steps in a method for trading items over a network, according to some embodiments.

FIG. 8 illustrates a flow chart including steps in a method for trading items over a network, according to some embodiments.

FIG. 9 illustrates a flow chart including steps in a method for shipping and delivering items traded over a network, according to some embodiments.

FIG. 10 is a diagram with steps in a method for shipping and delivering items traded over a network, according to some embodiments.

FIG. 11 illustrates a flow chart including steps in a method for providing and validating coupons over a network, according to some embodiments.

### DETAILED DESCRIPTION

The present disclosure relates to methods and systems for trading items over a network. Embodiments as disclosed herein communicate a user in one geographical location who wishes to barter goods and services with other users in different geographical locations. Methods and systems as disclosed herein are desirable when the traditional means of communication (e.g. travel, phone, mail) would be prohibitively costly. Also, methods and systems as disclosed herein may be desirable for users located in places where currency exchange is logistically difficult, or between users in geographic locations having different currency. For example, a user in India may desire to exchange or trade items with a user in Brazil or the Untied States. Moreover, embodiments consistent with the present disclosure may relate to users that desire to barter items for which it is difficult to establish a specific monetary value. This is specially desirable for antique collectors, stamp collectors, or other users that may put a special value on certain types of items or services.

Embodiments as disclosed herein allow users to barter with each other for items and services. Any visitor to the site can browse items/services and registered users can add items/services for trade or sale. In some embodiments, user registration is free.

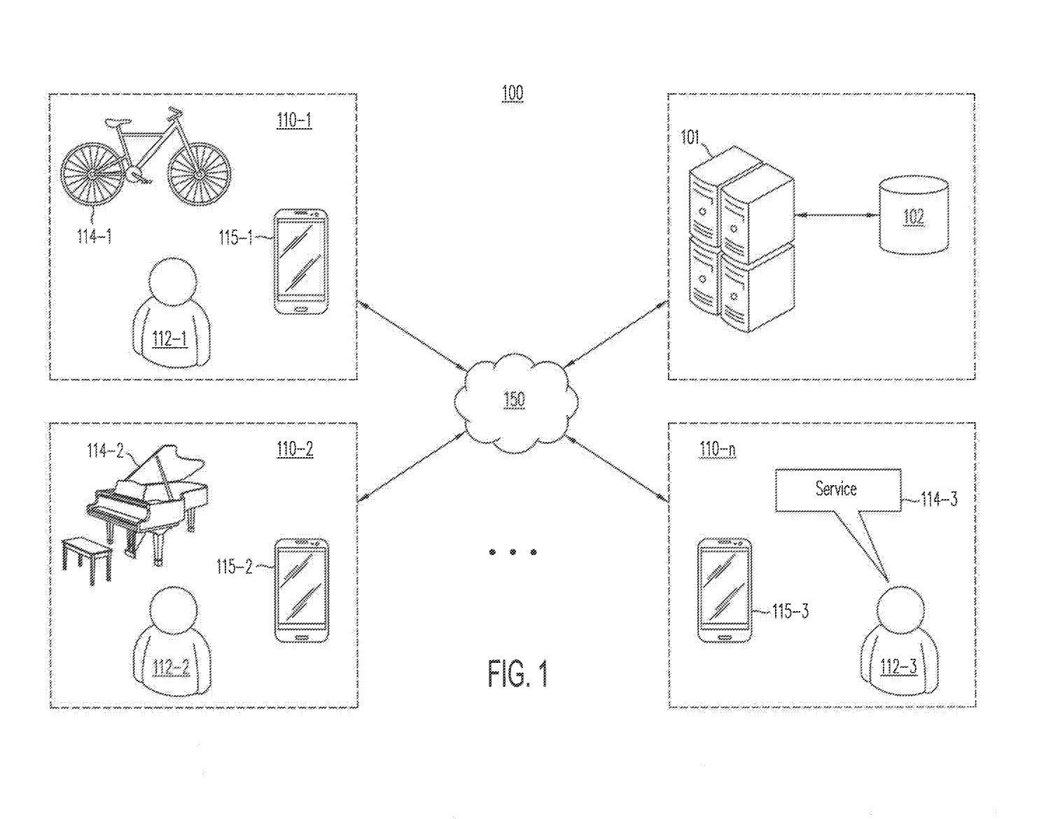

FIG. 1 illustrates a system 100 for trading items over a network 150, according to some embodiments. FIG. 1 illustrates network server 101 coupled to a database server 102. Network server 101 is associated with user accounts 110-1, 110-2, and 110-n (hereinafter collectively referred to as ‘user accounts 110’). Each user account corresponds to a user 112-1, 112-2, and 112-n (hereinafter collectively referred to as ‘users 112’). Accordingly, user accounts 110 may include at least one item 114-1, 114-2, and 114-n belonging to the user (hereinafter collectively referred to as ‘items 114’). Users 112 communicate with server 101 through network 150 via mobile devices 115-1, 115-2, and 115-n (hereinafter collectively referred to as mobile devices 115). The total number f user accounts, ‘n’, may be any integer value. It is understood that any number of user accounts may be serviced by network server 101 and database server 102.

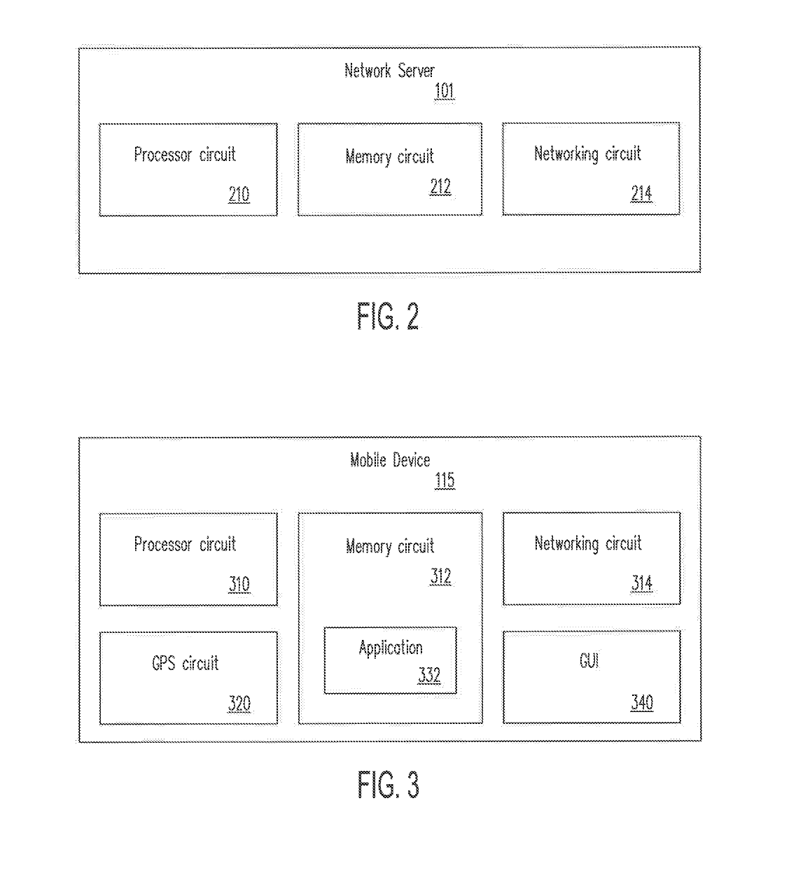

FIG. 2 illustrates a network server 101 for managing a user account in a system for trading items over a network, according to some embodiments. Network server 101 includes a processor circuit 210, a memory circuit 212, and a networking circuit 214. Memory circuit 212 includes commands which, when executed by processor circuit 210 cause network server 101 to perform steps in a method consistent with any one of the methods disclosed herein. Networking circuit 214 may include a transmitter, a receiver, or a transceiver configured to send and receive wired or wireless signals through network 150 (cf. FIG. 1) to other network servers (e.g., database server 102, cf. FIG. 1) or users registered with an account serviced by network server 101.

FIG. 3 illustrates a mobile device 115 for communicating with network server 101 in system 100, according to some embodiments. Mobile device 115 includes a processor circuit 310, a memory circuit 312, a networking circuit 314, and a Global Positioning System (GPS) circuit 320. Memory circuit 312 includes commands which, when executed by processor circuit 310 cause mobile device 115 to perform steps in a method consistent with any one of the methods disclosed herein. In some embodiments memory circuit 312 includes an application 332. Application 332 includes a set of commands installed in memory circuit 312 via networking circuit 314 communicating through network 150 from network server 101. Accordingly, commands in application 332 are executed by processor circuit 310 causing mobile device 115 to perform steps in methods consistent with the present disclosure.

Networking circuit 314 may include a transmitter, a receiver, or a transceiver configured to send and receive wireless signals through network 150 (ef. FIG. 1). GPS circuit 320 may be configured to identify a geo-location of mobile device 115 and associate the signals transmitted and received by networking circuit 314 with the gee-location coordinates of mobile device 115. Graphic user interface (GUI) 340 includes a display to present user 112 with web pages. The display in GUI 340 may include a touch sensitive display to receive input from user 112.

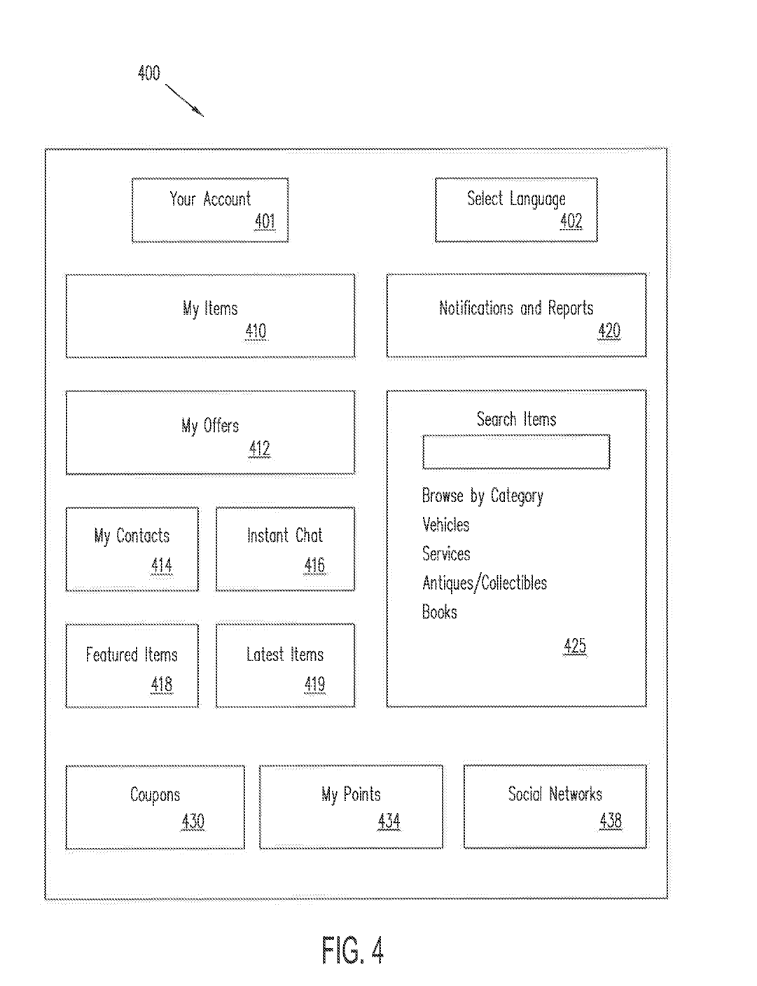

FIG. 4 illustrates a display 400 of a user account 401 in a system for trading items over network 150, according to some embodiments, Display 400 may be included in GUI 340 of mobile device 115 (cf. FIG. 3). Display 400 may be translated into any language selected by the user through a language selection field 402. In some embodiments the content generated in display 400 is translated into as many languages as possible. Accordingly, content generated by users 112 including items, messages, posts in groups, and others, is translatable through a network-based translation service or similar technologies.

A field 410 includes a ‘My Items’ list, which may include graphic displays of items 114 that user 112 has in account 401. A ‘notifications and reports’ field 420 includes notifications related to items 114 for which user 112 has placed an offer, or items 114 that user 112 has on display to receive offers. In some embodiments, user 112 is able to flag items 114 posted by other users that are illegal, fake, or weapons, If an item 114 is flagged, an administrator of network server 101 can delete that item from the system.

A field 412 includes a ‘My Offers’ list, including offers that user 112 may have received for items 114 in ‘My Items’ list 410. Field 412 may also include offers that user 112 has placed for items in a second user account. Accordingly, field 412 may include information about counter-offers placed by the second user, and a rating information for the offers of user 112. For example, when user 112 receives an offer for an item 114 from a second user, user 112 may place a rating to the offer. The rating may include a grading of the offer within a scale from one (1) to five (5), regarding the degree of acceptance of the offer by user 112. Likewise, when user 112 places an offer for an item in a second user account, the second user may rate the offer accordingly. In some embodiments, the user ratings of offers received or placed are published, The rating may be based on other offers that user 112 may have received for the same item, and thus would be an indicator for other users as to what are the expectations or likelihood that a new offer for the same item may be successful over existing offers.

A search field 425 enables user 112 to search for items 114 to barter. Search field 425 may be browsed by category (e.g., ‘Vehicles’, ‘Services,’ ‘Antiques/Collectibles,’ ‘Books,’ ‘Music,’ ‘Movies’). The search engine in field 425 is versatile and powerful. Accordingly, user 112 may search for terms in the description of an item 114 and the body of the item itself (when the item includes searchable text or fields). Search field 425 enables user 112 to browse by category, to browse through featured items and to browse by items according to location (closest to user, within a certain distance from user, etc.). Furthermore, in some embodiments, search field 425 may include a searchable map for browsing items according to a geographic location. For example, in some embodiments search field 425 is embedded in, a geo-coded map including navigation features. Accordingly, the user may navigate to a specific geographic area in the map, zoom in and out as desired, and then introduce a search term in search field 425 to find a certain type of item 114 within the selected geographic area. The system indicates on the map the locations of second users 112 that include at least one of items 114 similar to the item described in the search field,

In some embodiments, once user 112 finds a desirable item 114, user 112 selects the item by clicking on a button or link called “Create Offer.” User 112 is taken to a screen where user 112 selects at least one of the items 114 from ‘My Items’ list 410 and at least one of the items from the ‘My Items’ list in the second user's account. In some embodiments, user selection of items for barter is visual and simple, involving single clicks on icons or pictures on display 400. User 112 can cancel the offer at any time and return to browsing. Once satisfied, user 112 clicks on a button called “Make Offer,” User 112 is then presented with a screen indicating that the offer to the second user is finished and sent. The second user is sent an email and an in-site notification that an offer for barter at least some of the items in the second user's ‘My Items’ list 410 has been placed and is pending a reply. Any item 114 in a user's ‘My Items’ list 410 can be included in multiple offers. Any registered user 112 may select any item 114 from other users in the network, and view all third party offers involving that item. In some embodiments, a user 112 may desire to maintain at least one of the offers in ‘My Offers’ list 412 private. In some embodiments, a user 112 can pay to make one or more offers in ‘My Offers’ list 412 private and not viewable by others. In some embodiments, the default option is that an offer in ‘My Offers’ list 412 is viewable by other users. An offer can be cancelled at any time before it is accepted.

‘My Contacts’ field 414 may include links to other accounts that user 112 has selected as contacts. An instant chat field 416 establishes chats and other message exchanges with users in ‘My Contacts’ field 414. Registered users may transmit instant messages to each other, or leave messages. In some embodiments, a first user 112 can send an email to a second user 112 when the two users have exchanged their email address. In some embodiments, chat field 416 may include video, when the user's equipment and network connectivity so permits.

A ‘Featured Items’ field 418 displays items that may be of interest to user 112 and that are recently added to the network. Users should be able to set up lists of desirable items for barter. In some embodiments, to include a featured item in ‘Featured items’ list 418 the user may pay an extra fee. Users 112 can receive notifications in web account 401 and/or by email when a second user adds an item from the user's ‘My items’ list 410. A ‘Latest Items’ field 419 includes the latest items traded by user 112, or traded in the network, or within the ‘My Contacts’ list 414.

A coupons field 430 includes coupons offered by sponsors. Advertising in display 400 may include click-through advertising. Desirably. vendors and service providers advertise on display 400 in return for providing coupons to users 112 without drifting users away from display 400. When a vendor wishes to place an add in display 400, the vendor creates a coupon for display 400. To create a coupon, the vendor provides information to network server 101, including: title of the good or services offered, description of the good or service, location of the company, a logo for the company, terms and conditions of the coupon (e.g. number of coupons allowed per customer, expiration date, days on which the coupon is valid), dollar value of the good or service offered, whether the coupon is digital or needs to be printed out, Email address for the company (not visible to users). A vendor adding a coupon may indicate a user 112 that recommended the site to the vendor. Accordingly, in some embodiments user 112 earns points from the network server. Vendors can pay for optional properties, e.g. a featured coupon that shows up in a banner on the front page. Once created, the system can assign a point value to the coupon based on a dollar value. The network server can adjust the dollar value per point. In some embodiments, ‘Coupons’ field 430 includes a catalog of coupons earned by user 112 through rewards by activities in user account 401.

The catalog in ‘Coupons’ field 430 is searchable in the same way that the user-created items are. User 112 can browse coupons in ‘Coupons’ field 430 by popular coupons, or by proximity of the redeeming party (i.e., vendor). In some embodiments, coupons are displayed on a map indicating to the user the proximity of the vendor where the coupon may be redeemed. When user 112 browses and finds a coupon with a desirable offer, and for which user 112 has enough points, user 112 can redeem those points and collect the coupon. The coupon then is included in the catalog of ‘Coupons’ field 430. The points are deducted from the total points in ‘My points’ field 434. An e-mail is sent to user 112 and to the vendor. User 112 is informed as to how the vendor might redeem the coupon. In some embodiments user 112 is able to rate coupons and leave feedback on redeemed coupons. Some embodiments include a trip advisor and a ‘yelp’ type service so that users can read about vendors offering coupons in field 430. In some embodiments, ‘Coupons’ field 430 includes “charity” coupons. Instead of offering a coupon as described above, a vendor can donate a dollar amount to a charity. In some embodiments, ‘Coupons’ field 430 includes a banner add at the bottom of every page, with coupons rotating through it based on proximity to user 112 and language of user 112. Clicking on the banner ad takes user 112 to the page for redeeming the coupon. In some embodiments, the first coupon created by a vendor is free, and additional coupons accrue a pre-selected cost to the vendor, according to a schedule.

A field 434 keeps a ‘My Points’ record of points that user 112 may exchange for selected coupons. In some embodiments the network server is configured to add points to ‘My points’ record 434 according to specific milestones. Examples of milestones may be, without limitation: the 100^{th} user to join the network, the 500^{th}, the 1000^{th}, and the like. The user who uploads the 100^{th} item the 500^{th}, the 1000^{th}, and the like. The user who completes the 100^{th} transaction, the 500^{th}, the 1000^{th}, and the like. Some embodiments include a monthly electronic drawing for giving points to randomly selected users. Some actions that may earn user 112 an electronic ticket into the drawing include, without limitation: adding an item to ‘My items’ field 410, inviting a friend to sign up with the network server. successfully completing a transaction with positive feedback from the second user (counterpart), posting an item 114 from ‘My items’ field 410 to a social media account (e.g., Facebook, LinkedIn, Google+ or the like). User 112 can earn multiple points per day, while some embodiments include a maximum number of points a user can earn per day. At the end of the month. the system randomly selects a number of winners to receive gift certificates, points, or coupons. User names of the winners are posted on the site. At the beginning of every month each user 112 starts over with zero (0) points. The number of points earned per activity is re-configurable by a network server agent.

For the same actions that earn them electronic tickets, users will earn points. Points will be redeemable for coupons that vendors make available. In some embodiments, points earned by user 112 do not expire. In some embodiments, points are not redeemable for anything except coupons. Furthermore, in some embodiments points may be purchased by user 112 and even be traded for items with a second user. The number of points earned per activity is configurable by a network server agent.

A social networks field 438 may link account 401 with any one of a plurality of social networking sites where user 112 may have accounts. In some embodiments, user 112 may find it convenient to integrate account 401 with other major social networking available such as, but without limitation: Facebook, Twitter, LinkedIn and others. Users 112 may invite friends, post items on their walls, using social networks field 438. Actions associated with social networks field 438 may be configured for manual input by user 112. In some embodiments, user 112 may select some social networking activity to be automatically performed by the network server. In some embodiments, user 112 may create Facebook-like groups and profiles on account 401.

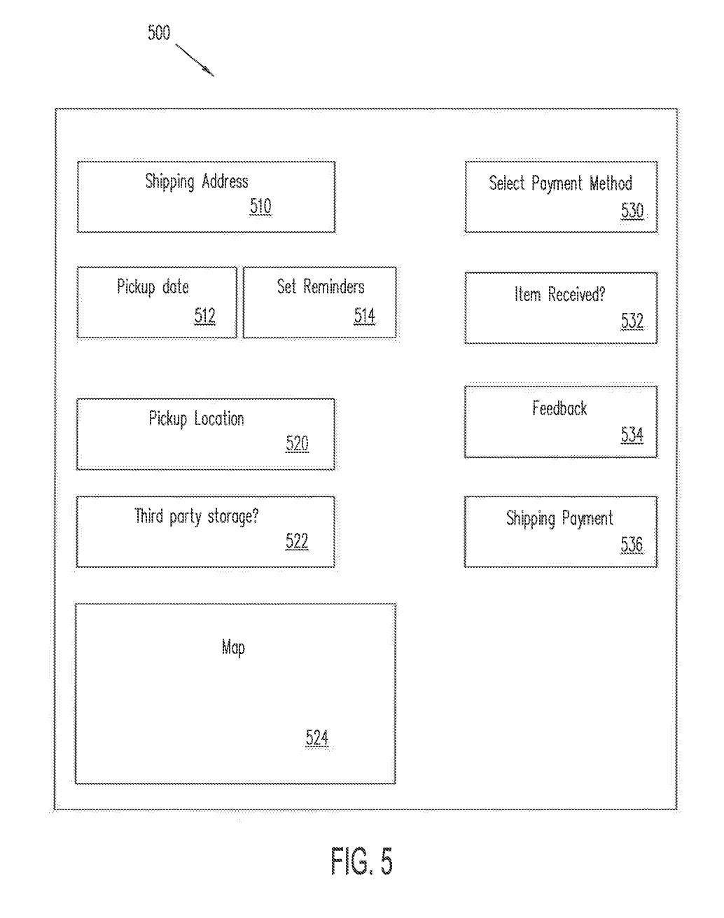

FIG. 5 illustrates a display 500 for shipping and delivery of items in a method for trading items over a network, according to some embodiments. A field for a shipping address 510 is used by the first and second user to place an address or IP credentials so that the exchanged item may be shipped to the new user. A field for selecting a pickup date 512 receives a pickup date from each one of the first and second users for pickup of the exchanged items. A field for setting reminders 514 enables the first and second users to schedule reminders about the pickup date. A field 520 allows the first and second user to select a pickup location for the exchanged items. A field 522 allows the first and second users to select a third party storage location. Accordingly, in some embodiments the first and second users may specify that the first and second item go to a third party storage location prior to being shipped to the first and second users. In such configurations, the first and second users may ensure that the barter contract is satisfied before authorizing the third party storage to release the exchanged item to the other party. Namely, in some embodiments the third party storage may be configured to send a message to the first and second user when the item from the counterpart have arrived to the third party storage location. A map 524 may facilitate the choice of a convenient third party storage location for the first and second user. A field 530 receives the payment method selected by the first user and the second user. A field 532 receives input as to whether or not the item was received by the first or second user, and in what condition. A field to provide feedback 534 enables the first or second user to determine if the counterpart was reliable during the transaction. And a field 536 receives a selection of a payment method for the shipping costs. In some embodiments, each of the first and second users pays for the shipment of the first or second item, respectively, to the counterpart. In some embodiments, the first user pays for the shipment of the second item, and the second user pays for the shipment of the first item. In some embodiments, either one of the first or second users may pay for the shipment of the first and second items.

In some embodiments the first and second users may select to personally pickup the items at the third party storage location. Thus, the first and second users decide to arrange a pick up time and location and the network server stores location and time of the pickup and sends email reminders to the first and second users. The screen could include links to google maps in order to help facilitate pick. Once offers are completed and items shipped/received the users should be able to leave feedback about the transaction. This should consist of a rating and verbal feedback. As part of the process a user should be able to specify that once an item has been shipped and received, the system automatically add it to their inventory.

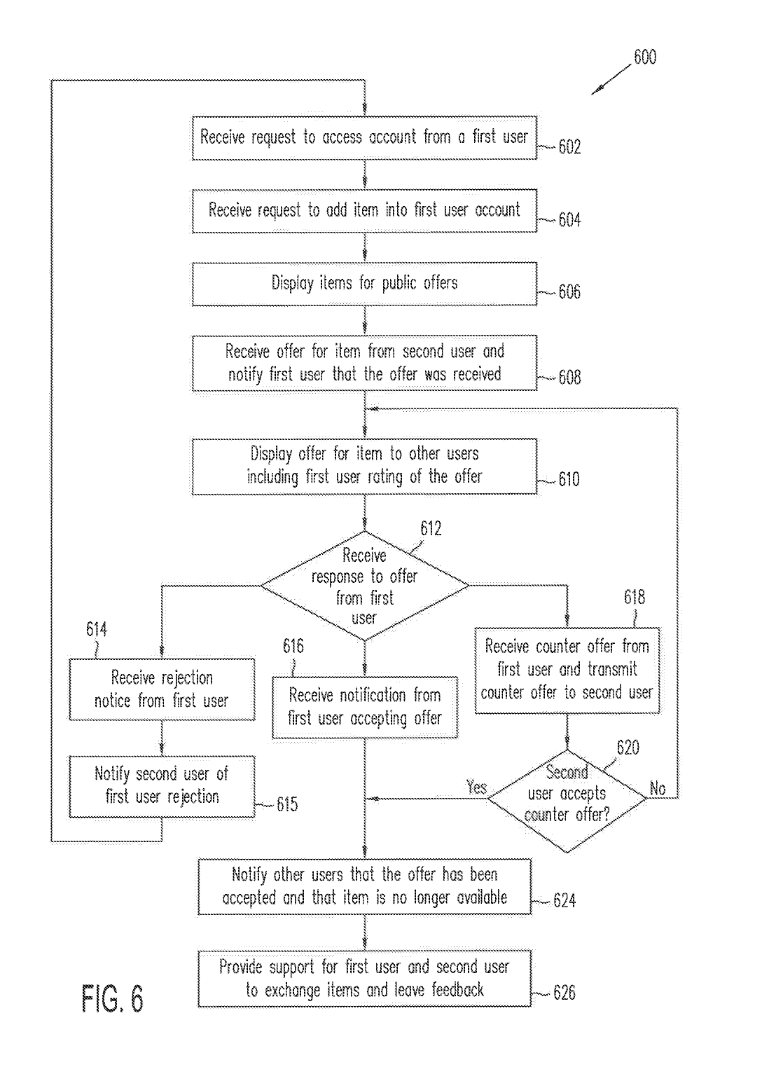

FIG. 6 illustrates a flow chart including steps in a method 600 for trading items over a network, according to some embodiments. In some embodiments, steps in method 600 are at least partially performed by a network server having a processor circuit and a memory circuit and being the communicatively coupled to a database server (e.g., network server 101, database server 102, processor circuit 210, and memory circuit 212, cf. FIGS. 1 and 2). Accordingly, the network server may service user accounts for a plurality of registered users, in a plurality of geographic locations, and desiring to exchange or barter items with other registered users in the network (e.g., users 112 and items 114, cf. FIG. 1). Methods consistent with method 600 may include at least one but not all of the steps illustrated in FIG. 6. In some embodiments, methods consistent with the present disclosure may include at least some of the steps illustrated in FIG. 6, but in different order. More generally, methods consistent with method 600 may include at least some of the steps in FIG. 6 performed overlapping in time. In some embodiments, at least two of the steps in FIG. 6 may be performed simultaneously or almost simultaneously in time. In some embodiments, method 600 includes a user communicating with the network server through a mobile device. In some embodiments, the network server performs all steps in method 600 at no charge to a registered user.

Users may register to the services provided by the network server in method 600 by logging in via a social network server such as Facebook. In some embodiments, a user creates a user account providing an email address and creating a password with the network server. In some embodiments, no email confirmation may be requested from the user.

Step 602 includes receiving a request to access an account from a first user. Once a visitor has registered they can create an “inventory” by adding any number of items or services to offer. Step 604 includes receiving a request to add an item to the first user account. At any time users can add an item to or subtract an item from that inventory. There is no limit on the number of items a user can have in their inventory at any one time. In some embodiments, adding an item to the inventory is free. To add an item or service the user fills out a simple form. The form may include: a title, a description, a picture (if user does not have a picture they can choose from a database of stock pictures). The user can add multiple pictures of the same item, but only one is displayed at a time. The pictures may be stored in the user account, for the user to choose the picture to be on public display at any given moment. The item/service location (the user can have a default location in their profile and this field is auto filled or the site can fill it based on where the user is browsing from), a list of tags, the category or categories, registered users can ask questions about an item. The owner of the item can choose to display question and answer on the items page. They can have as many different items as they want and they can have different quantities for each item.

Step 606 includes displaying the items in the user account for public access to receive offers from other users. Step 608 includes receiving an offer for an item from a second user and notifying the first user that the offer was received. Step 610 includes displaying the offer for item to other users. In some embodiments, step 610 includes displaying a first user rating of the offer. They can do nothing essentially waiting to see if they get any other offers from other users so they can pick and choose the best one. At any point in time they can return to any of these options.

Step 612 includes receiving a response to the first user offer. Accordingly, step 614 includes receiving a rejection of the offer by the first user. Step 615 includes notifying the second user of the first user rejection. Step 616 includes receiving a notification from the first user accepting the offer. Step 616 includes notifying the first user and the second user that the offer is accepted. Further, step 616 may include prompting the first user and the second user to visit a screen to work out the details of how the items/services will be exchanged. If any of the items/services in the offer are part of any other offers pending with other users, those other offers are cancelled and the corresponding users notified. Step 618 includes receiving a counter offer from the first user. In some embodiments, step 618 also includes transmitting the counter offer by the first user to the second user. This consists of essentially the same screen used to create the offer, but already filled in. The first and second users would then add/subtract their own items or items from the user who made the last offer. The other user is notified and has the same options of adding/subtracting its own items or items from the counterpart. Step 620 includes determining whether the second user accepts the counter offer of the first user. Step 624 includes notifying other users that the offer has been accepted by the first user. In some embodiments step 624 includes notifying other users that the item is no longer available. Step 626 includes providing support for user and offering party to exchange items and leave feedback.

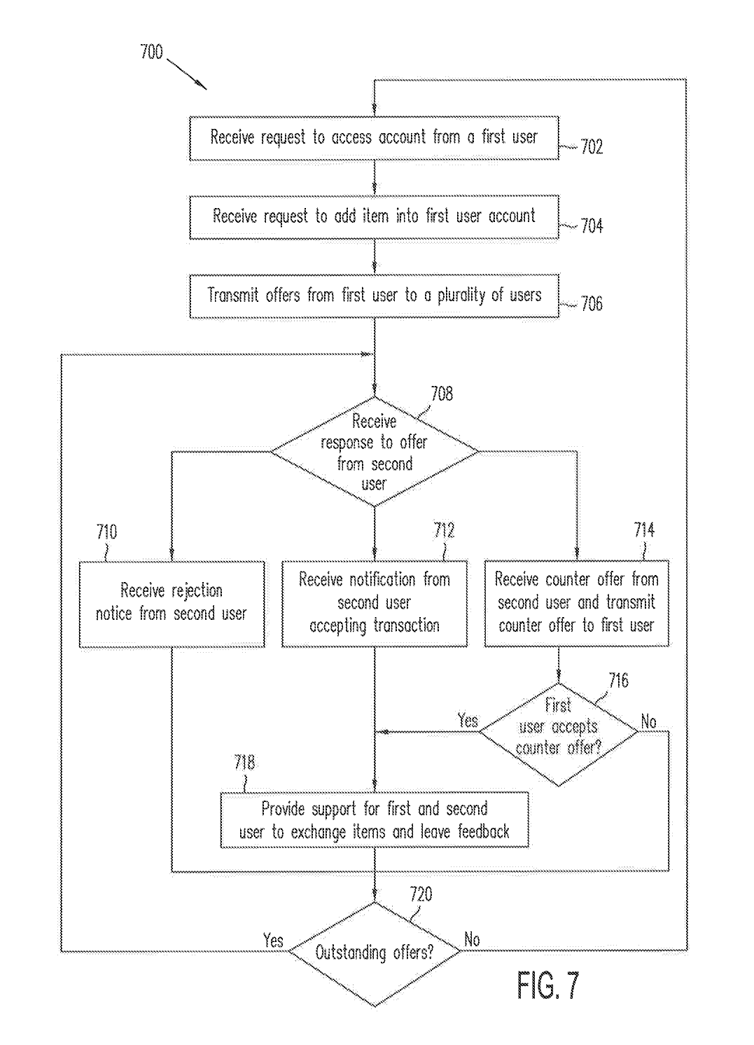

FIG. 7 illustrates a flow chart including steps in a method 700 for trading items over a network, according to some embodiments. In some embodiments, steps in method 700 are at least partially performed by a network server having a processor circuit and a memory circuit, the network server communicatively coupled to a database server (e.g., network server 101, database server 102, processor circuit 210, and memory circuit 212, cf. FIGS. 1 and 2). Accordingly, the network server may service user accounts for a plurality of registered users, in a plurality of geographic locations, and desiring to exchange or barter items with other registered users in the network (e.g., users 112 and items 114, cf. FIG. 1), Methods consistent with method 700 may include at least one but not all of the steps illustrated in FIG. 7. In some embodiments, methods consistent with the present disclosure may include some of the steps illustrated in FIG. 7, performed in a different order. More generally, methods consistent with method 700 may include at least some of the steps in FIG. 7 performed overlapping in time. In some embodiments, at least two of the steps in FIG. 7 may be performed simultaneously or almost simultaneously in time.

Step 702 includes receiving a request to access an account from a first user, Step 704 includes receiving a request to add an item into the first user account. Step 706 includes transmitting offers from the first user to a plurality of users. Step 708 includes receiving a response to a first user offer from a second user. Accordingly, step 710 includes receiving a rejection notice from the second user in the response. Step 712 includes receiving a notification from the second user accepting the transaction. Step 714 includes receiving a counter offer from the second user and transmit the counter offer to the first user. Step 716 includes determining whether the first user accepts the counter offer. When the first user accepts the counter offer, or when the second user accepts the first user offer, step 718 includes providing support for the first user and the second user to exchange items and leave feedback. When it is determined that the first user does not accept the counter offer in step 716, or when the second user rejects the first user offer in step 710, step 720 includes determining whether there are any outstanding offers placed by the first user. When there are outstanding offers, method 700 repeats steps 708 through 718. When there are no outstanding offers, method 700 repeats steps 702 through 720.

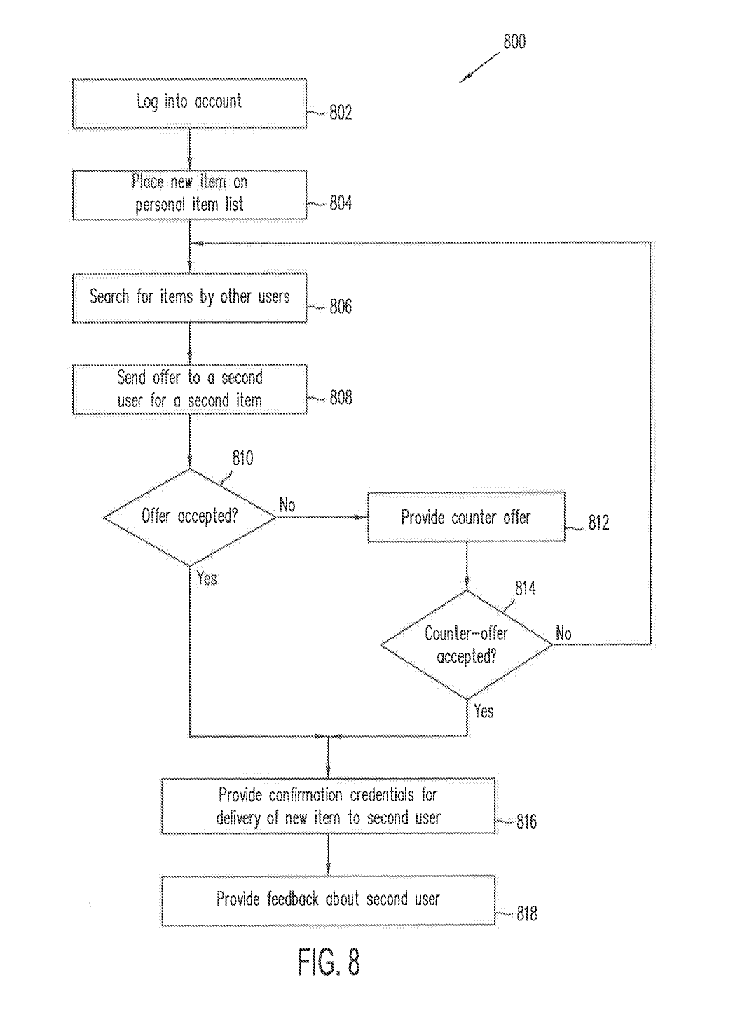

FIG. 8 illustrates a flow chart including steps in a method 800 for trading items over a network, according to some embodiments. In some embodiments, steps in method 800 are at least partially performed by a mobile device having a processor circuit and a memory circuit, the mobile device communicatively coupled to a network server and a database server (e.g, mobile device 115, network server 101, database server 102, processor circuit 310, and memory circuit 312, cf. FIGS. 1 and 3). Accordingly, the mobile device may communicate with other registered users of the network server, the other registered users being in a plurality of geographic locations, and desiring to exchange or barter items in the network (e.g., users 112 and items 114, cf. FIG. 1). The mobile device in method 800 may include a GPS circuit to determine the geo-location of the mobile device (e.g., GPS circuit 320, cf. FIG. 3). Methods consistent with method 800 may include at least one but not all of the steps illustrated in FIG. 8. In some embodiments, methods consistent with the present disclosure may include some of the steps illustrated in FIG. 8, but in different order. More generally, methods consistent with method 800 may include at least some of the steps in FIG. 8 performed overlapping in time. In some embodiments, at least two of the steps in FIG. 8 may be performed simultaneously or almost simultaneously in time.

Step 802 includes logging into an account. Step 804 includes placing a new item on the personal items list. Step 806 includes searching for items by other users. Step 808 includes sending an offer to a second user for a second item. Step 806 may be performed multiple times by the first user, offering the same item to different users. The first user can also receive offers from other users. Once a user receives an offer they can accept or reject the offer or simply wait.

Until an offer is accepted or rejected, the offer is visible to a registered user (not just the two persons involved). Any user can view an offer involving an item by clicking an icon next to the item. By viewing existing offers involving an item, a user can better decide what they might need to offer for the item. A person who receives an offer, can rate that offer (in order to give other interested users an idea of which offers they find favorable).

Step 810 includes determining whether the offer is accepted. Once an offer is accepted, both parties receive emails and are directed to the site in order to exchange their items. When the offer is accepted, step 816 includes providing confirmation credentials for delivery of new item to the second user. When the offer is not accepted, step 812 includes providing a counter offer to the second user. Step 814 includes determining whether the counter offer is accepted by the second user. When the counter offer is not accepted, method 800 performs steps 806 and 808. When the counter offer is accepted, or when the original offer is accepted as determined in step 810, step 816 includes providing confirmation credentials for delivery of new item to the second user. And step 818 includes providing feedback about the second user.

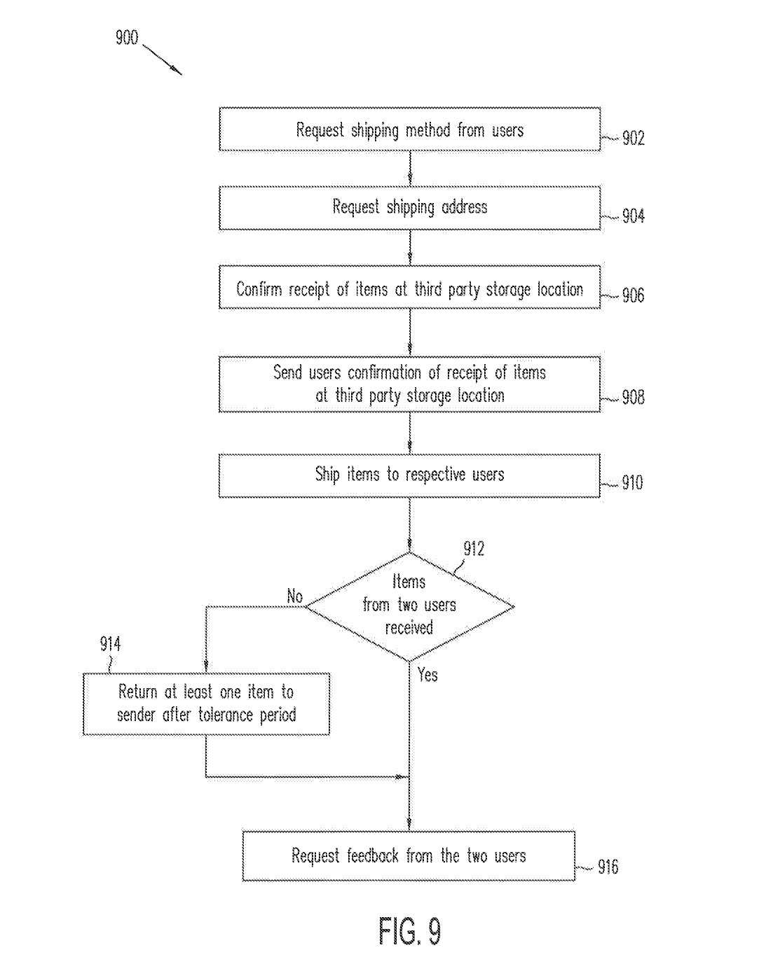

FIG. 9 illustrates a flow chart including steps in a method 900 for shipping and delivering items traded over a network, according to some embodiments. In some embodiments, steps in method 900 are at least partially performed by a network server having a processor circuit and a memory circuit, the network server communicatively coupled to a database server (e.g., network server 101, database server 102, processor circuit 210, and memory circuit 212, cf. FIG. 2). Accordingly, the network server may service user accounts for a plurality of registered users, in a plurality of geographic locations, and desiring to exchange or barter items with other registered users in the network (e.g., users 112 and items 114, cf. FIG. 1). Methods consistent with method 900 may include at least one but not all of the steps illustrated in FIG. 9. In some embodiments, methods consistent with the present disclosure may include some of the steps illustrated in FIG. 9, but in different order. More generally, methods consistent with method 900 may include at least some of the steps in FIG. 9 performed overlapping in time. In some embodiments, at least two of the steps in FIG. 9 may be performed simultaneously or almost simultaneously in time.

Step 902 includes requesting a shipping method from users. Step 904 includes requesting a shipping address from the users. Step 906 includes confirming receipt of items at a third party storage location. Step 908 includes sending interested parties a picture and description of items received in third party storage. Step 912 includes determining whether or not each of the users received their respective items. Step 914 includes returning at least one item to sender after a tolerance period has expired with the other user not receiving the exchange item. Step 910 includes shipping items to respective users. And step 916 includes requesting feedback from the two users.

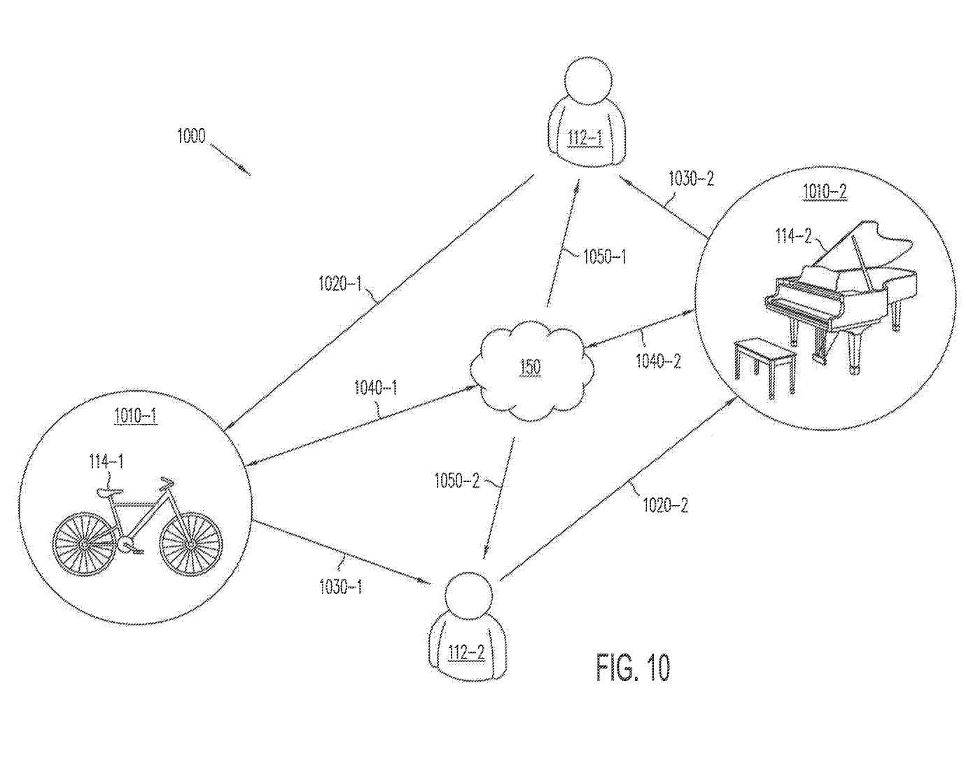

FIG. 10 is a diagram with steps in a method 1000 for shipping and delivering items 114-1 and 114-2 traded over a network 150, according to some embodiments. In method 1000, first user 112-1 trades item 114-1 for item 114-2 of user 112-2, via third party storage locations 1010-1 and 1010-2. In step 1020-1 user 112-1 ships item 114-1 to storage location 1010-1. In step 1020-2 user 112-2 ships item 114-2 to storage location 1010-2. When storage location 1010-1 receives item 114-1 from user 114-1, storage location 1010-1 communicates to user 112-2 that the item is in storage. The communication is performed through a network channel including communication link 1040-1 between storage location 1010-1 and network 150, and communication link 1050-2 between user 112-2 and network 150. Likewise, when storage location 1010-2 receives item 114-2 from user 112-2, storage location 1010-1 communicates to user 112-1 that the item is in storage. The communication is performed through a network channel including communication link 1040-2 between storage location 1010-2 and network 150, and communication link 1050-1 between user 112-1 and network 150.

When users 112 receive notification that the item of their interest has been released by the owner and is ready for shipping to their new owner, the users may provide confirmation to each respective storage location that the message has been received. Accordingly, the storage location releases the items to each user. For example, user 112-2 communicates to storage location 1010-1 that the message has been received. Further, storage 1010-2 may communicate with storage 1010-1 to exchange information about items 114-2 and 114-1. Accordingly, in step 1030-1 storage 1010-1 ships item 114-1 to user 112-2 when it has received confirmation that item 114-2 is in storage 1010-2. By the same token, in step 1030-2 storage location 1010-2 ships item 114-2 to user 112-1, once it has received confirmation that item 114-1 has been received in storage location 1010-1.

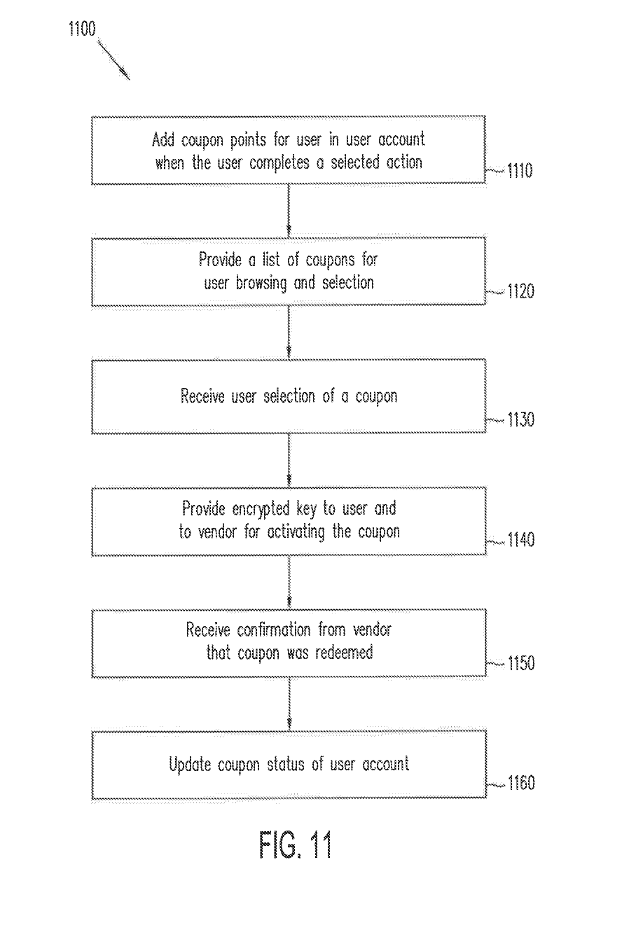

FIG. 11 illustrates a flow chart including steps in a method 1100 for providing and validating coupons to users over a network, according to some embodiments. In some embodiments, steps in method 1100 are at least partially performed by a network server having a processor circuit and a memory circuit, the network server communicatively coupled to a database server (e.g., network server 101, database server 102, processor circuit 210, and memory circuit 212, cf. FIG. 2). Accordingly, the network server may service user accounts for a plurality of registered users, in a plurality of geographic locations, and desiring to exchange or barter items with other registered users in the network (e.g., users 112 and items 114, cf. FIG. 1). Methods consistent with method 1100 may include at least one but not all of the steps illustrated in FIG. 11. In some embodiments, methods consistent with the present disclosure may include some of the steps illustrated in FIG. 11, but in different order. More generally, methods consistent with method 1100 may include at least some of the steps in FIG. 11 performed overlapping in time. In some embodiments, at least two of the steps in FIG. 11 may be performed simultaneously or almost simultaneously in time,

Step 1110 includes adding coupon points for a user account when the user completes a selected action. Step 1120 includes providing a list of coupons for the user to browse and select. Step 1130 includes receiving a user selection of a coupon. Step 1140 includes providing an encrypted key to the user and to the vendor for activating the coupon. Step 1150 includes receiving a confirmation from the vendor that a coupon was redeemed. And step 1160 includes updating the coupon status of the user account.

Embodiments disclosed herein are encompassed by the following concepts:
Concept 1. A method, comprising:

receiving a request to access an account by a first user;

receiving a request to add an item to the first user account;

displaying at least one of a plurality of items in the first user account for a public offer;

receiving an offer for the at least one item from a second user, the offer comprising an exchange request for a second user item;

notifying the first user of the offer received;

receiving a rating assigned to the second user offer by the first user;

displaying the second user offer and the first user rating publicly;

receiving a response to the second user offer by the first user; and

notifying other users that the at least one item is no longer available when the first user accepts the second user offer.
Concept 2. The method of concept 1, further comprising requesting a shipping method from the first user and the second user for exchanging the traded items.

Concept 3. The method of any one of concepts 1 and 2, further comprising notifying the second user of the first user rejection when the first user rejects the second user offer.
Concept 4. The method of one of concepts 1 through 3, further comprising:

receiving a counter offer from the first user in response to the offer for at least one item; and

transmitting the counter offer to the second user.
Concept 5. The method of one of concepts 1 through 4, further comprising requesting the first user and the second user to leave a feedback regarding the transaction.
Concept 6. The method of one of concepts 1 through 5, further comprising displaying a location of the first user for public view, the location associated with the at least one item.
Concept 7. A mobile computer device comprising:

a wireless networking circuit configured to communicate with a remote network server;

a memory circuit storing commands;

a processor circuit configured to execute the commands causing the mobile computer device to:
request access to a personal account in the network server;
request to add a first item for trade into the personal account; and
offer the first item to a second user in exchange of a second item in a second user account; and

a global positioning system (GPS) circuit, configured to provide a geo-coordinate of the mobile device location to the network server.
Concept 8. The mobile computer device of concept 7, wherein the processor circuit communicates the gee-coordinate to the network server when the second user accepts the offer; and

the processor circuit in the mobile device further causes the mobile device to receive a geo-coordinate indicating the location of the second user.
Concept 9, The mobile computer device of one of concepts 7 and 8, wherein the processor circuit is further configured to cause the mobile device to select a coupon from a coupon list presented by the network server, the selection based on a set of points awarded to the personal account by the network server.
Concept 10. The mobile computer device of one of concepts 7 through 9, wherein the processor circuit is further configured to cause the device to offer the first item for trade to a third user in exchange of a third item in a third user account, when the second user has not accepted the offer.
Concept 11. The mobile computer device of one of concepts 7 through 10, wherein the processor circuit is further configured to cause the device to receive a counter offer by the second user for the first item.
Concept 12. The mobile computer device of one of concepts 7 through 11, wherein the processor circuit is further configured to retrieve an offer rating by the second user.
Concept 13. The mobile computer device of one of concepts 7 through 12, wherein the processor circuit is further configured to:

receive from the first user a feedback rating of the second user; and transmit to the network server the feedback rating of the second user.
Concept 14. The mobile computer device of one of concepts 7 through 13, wherein the processor circuit is further configured to receive a confirmation credential from the network server in order to retrieve the second item from a third party storage location.
Concept 15. A method comprising:

displaying a plurality of items for trade, the items belonging to at least a first user and a second user willing to trade the items;

communicating an offer and a counter offer for a subset of the plurality of items for trade between the first user and the second user;

communicating to a third user that the subset of the plurality of items for trade is no longer available;

receiving a selection for a shipping method from the first user and the second user; confirming a receipt of the subset of the plurality of items at a third party storage location; and

requesting feedback from the first user and the second user when at least one of a tolerance period has lapsed, or the first user and the second user have received their desired items.
Concept 16. The method of concept 15, further comprising providing a map to each of the first user and the second user indicating the location of the third party storage location, the map also indicating a geo-location of at least the first user or the second user.
Concept 17. The method of one of concepts 15 and 16, further comprising providing a reminder to the first user and to the second user, when the shipping date of the first item and the second item is due.
Concept 18, The method of concepts 15 through 17, further comprising providing security credentials to the first user and the second user to retrieve the items from the third party storage location.
Concept 19. The method of one of concepts 15 through 18, wherein the third party storage location comprises a first storage location near the second user and a second storage location near the first user, further comprising;

receiving from the first storage location a first message when the first item from the first user has arrived; and

receiving from the second storage location a second message when the second item has arrived.
Concept 20. The method of concept 19, further comprising:

sending the first message to the second storage location;

sending the second message to the first storage location;

upon receipt of the first message, instructing the second storage>location to ship the second item to the first user; and

upon receipt of the second message, instructing the first storage location to ship the first item to the second user.
Concept 21. A non-transitory, computer readable medium storing instructions which, when executed by a processor in a computer, cause the computer to perform a method comprising:

displaying a plurality of items in a first user account for a public offer;

receiving an offer for at least one item from the plurality of items in the first user account from a second user, the offer comprising an exchange request for a second item in a second user account;

displaying the second user offer and a first user rating of the second user offer, publicly;

receiving a response to the second user offer by the first user; and

notifying other users that the at least one item is no longer available when the first user accepts the second user offer.
Concept 22. The non-transitory, computer readable medium of concept 21, further comprising instructions for requesting a shipping method from the first user and the second user for exchanging the traded items.
Concept 23. The non-transitory, computer readable medium of one of concepts 21 and 22, further comprising instructions for notifying the second user of the first user rejection when the first user rejects the second user offer.
Concept 24. The non-transitory, computer readable medium of one of concepts 21 through 23, further comprising instructions for:

receiving a counter offer from the first user in response to the offer for at least one item; and

transmitting the counter offer to the second user.
Concept 25. The non-transitory, computer readable medium of one of concepts 21 through 24, further comprising instructions for requesting the first user and the second user to leave a feedback regarding the transaction.
Concept 26. The non-transitory, computer readable medium of one of concepts 21 through 25, further comprising instructions for displaying a location of the first user for public view, the location associated with the at least one item.
Concept 27. The non-transitory, computer readable medium of one of concepts 21 through 26, further comprising instructions for providing a map to each of the first user and the second user indicating the location of a third party storage location for the exchange of the first item and the second item, the map also indicating a geo-location of at least the first user or the second user.
Concept 28. The non-transitory, computer readable medium of one of concepts 21 through 27, further comprising instructions for providing a reminder to the first user and to the second user. when a shipping date for shipping the first item and the second item is due.
Concept 29. The non-transitory, computer readable medium of concept 27, further comprising instructions for providing security credentials to the first user and the second user to retrieve the items from the third party storage location.
Concept 30. The non-transitory, computer readable medium of concept 27, wherein the third party storage location comprises a first storage location near the second user and a second storage location near the first user, further comprising instructions for:

receiving from the first storage location a first message when the first item from the first user has arrived; and

receiving from the second storage location a second message when the second item has arrived.
Concept 31. The non-transitory, computer readable medium of concept 30, further comprising instructions for:

sending the first message to the second storage location;

sending the second message to the first storage location;

upon receipt of the first message, instructing the second storage location to ship the second item to the first user; and

upon receipt of the second message, instructing the first storage location to ship the first item to the second user.
Concept 32. A computer device, comprising:

a memory circuit storing commands;

a networking circuit;

a processor circuit configured to execute the commands, causing the computer to perform the steps of:
providing, a user of a mobile computer device access to a first user account;
receiving from the user a request to include an item in the first user account;
displaying the item for trade in a network of user accounts;
providing an offer for the item to the first user from a second user; and
notifying other users that the item is no longer available when the first user accepts the offer from the second user.
Concept 33. The computer device of concept 32, further configured to perform the step of providing a counter offer from the first user to the second user.
Concept 34. The computer device of one of concepts 32 and 33, further configured to perform the step of supporting the first user and the second user to ship exchanged items to each other.
Concept 35. The computer device of one of concepts 32 through 34, further configured to perform the step of receiving and storing feedback from the first and the second user about each other.
Concept 36. The computer device of one of concepts 32 through 35, further configured to perform the step of communicating to a third user that the item for trade is no longer available.
Concept 37. The computer device of one of concepts 32 through 36, further configured to perform the step of confirming a receipt of the item at a third party storage location.
Concept 38. The computer device of one of concepts 32 through 37, further configured to perform the step of receiving through the networking circuit a geo-location for the first and the second users, and providing a map to the first and the second users displaying the geo-location of the first and the second users relative to a third party storage location that receives the traded items.
Concept 39. The computer device of one of concepts 32 through 38, further configured to perform the step of providing security credentials to the first user and the second user to retrieve the exchanged items from a third party storage location.
Concept 40. The computer device of one o concepts 32 through 39, further configured to perform the steps of:

receiving from the first user a feedback rating of the second user; and

receiving from the second user a feedback rating of the first user,

While several embodiments have been disclosed and discussed in detail, it is understood that any combinations of the different embodiments disclosed are included within the scope of the present disclosure, as one of ordinary skill in the art will immediately recognize from the present disclosure. Each and all of the possible combinations and permutations of different elements in the disclosed embodiments are included within the scope of the present disclosure, and will not be described in detail here for conciseness.

As will be appreciated, the present disclosure is capable of other and different embodiments and its several details are capable of modifications in various aspects that will be obvious to one skilled in the art, all without departing from the scope of the present disclosure. Accordingly, the drawings and the descriptions included herein are to be regarded as illustrative in nature and not restrictive. The scope of the disclosure herein is defined by the following claims.

1. A method, comprising:
receiving a request to access an account by a first user;
receiving a request to add an item to the first user account;
displaying at least one of a plurality of items in the first user account for a public offer;
receiving an offer for the at least one item from a second user, the offer comprising an exchange request for a second user item:
notifying the first user of the offer received;
receiving a rating assigned to the second user offer by the first user;
displaying the second user offer and the first user rating publicly;
receiving a response to the second user offer by the first user; and
notifying other users that the at lest one item is no longer available when the first user accepts the second user offer.

2. The method of claim 1, further comprising requesting a shipping method from the first user and the second user for exchanging the traded items.

3. The method of claim 1, further comprising notifying the second user of the first user rejection when the first user rejects the second user offer.

4. The method of claim 1, further comprising:
receiving a counter offer from the first user in response to the offer for at least one item: and transmitting the counter offer to the second user.

5. The method of claim 1, further comprising requesting the first user and the second user to leave a feedback regarding the transaction.

6. The method of claim 1, further comprising displaying a location of the first user for public view, the location associated with the at least one item.

7. A mobile computer device comprising.
a wireless networking circuit configured to communicate with a remote network server;
a memory circuit storing commands;
a processor circuit configured to execute the commands causing the mobile computer device to:
request access to a personal account in the network server;
request to add a first item for trade into the personal account; and
offer the first item to a second user in exchange of a second item in a second user account; and
a global positioning system (GPS) circuit, configured to provide a geo-coordinate of the mobile device location to the network server.

8. The mobile computer device of claim 7, wherein the processor circuit communicates the geo-coordinate to the network server when the second user accepts the offer; and
the processor circuit in the mobile device further causes the mobile device to receive a geo-coordinate indicating the location of the second user.

9. The mobile computer device of claim 7, wherein the processor circuit is further configured to cause the mobile device to select a coupon from a coupon list presented by the network server, the selection based on a set of points awarded to the personal account by the network server.

10. The mobile computer device of claim 7, wherein the processor circuit is further configured to cause the device to offer the first item for trade to a third user in exchange of a third item in a third user account, when the second user has not accepted the offer.

11. The mobile computer device of claim 7, wherein the processor circuit is further configured to cause the device to receive a counter offer by the second user for the first item.

12. The mobile computer device of claim 7, wherein the processor circuit is further configured to retrieve an offer rating by the second user.

13. The mobile computer device of claim 7, wherein the processor circuit is further configured to:
receive from the first user a feedback rating of the second user; and
transrnit to the network server the feedback rating of the second user.

14. The mobile computer device of claim 7, wherein the processor circuit is further configured to receive a confirmation credential from the network server in order to retrieve the second item from a third party storage location.

15. A method comprising:
displaying a plurality of items for trade, the items belonging to at least a first user and a second user willing to trade the items;
communicating an offer and a counter offer for a subset of the plurality of iterns for trade between the first user and the second user;
communicating to a third user that the subset of the plurality of terns for trade is no longer available;
receiving a selection for a shipping method from the first user and the second user;
confirming a receipt of the subset of the plurality of items at a third party storage location; and
requesting feedback from the first user and the second user when at least one of a tolerance period has lapsed, or the first user and the second user have received their desired items.

16. The method of claim 15, further comprising providing a map to each of the first user and the second user indicating the location of the third party storage location, the map also indicating a geo-location of at least the first user or the second user.

17. The method of claim 15, further comprising providing a reminder to the first user and to the second user, when the shipping date of the first item and the second item is due.

18. The method of claim 15, further comprising providing security credentials to the first user and the second user to retrieve the items from the third party storage location.

19. The method of claim 15, wherein the third party storage location comprises a first storage location near the second user and a second storage location near the first user, further comprising:
receiving from the first storage location a first message when the first item from the first user has arrived; and
receiving from the second storage location a second message when the second item has arrived.

20. The method of claim 19, further comprising:
sending the first message to the second storage location;
sending the second message to the first storage location;
upon receipt of the first message, instructing the second storage location to ship the second item to the first user; and
upon receipt of the second message, instructing the first storage location to ship the first item to the second user.

21. A non-transitory, computer readable medium storing instructions which, when executed by a processor in a computer, cause the computer to perform a method comprising;
displaying a plurality of items in a first user account for a public offer;
receiving an offer for at least one item from the plurality of items in the first user account from a second user, the offer comprising an exchange request for a second item in a second user account;
displaying the second user offer and a first user rating of the second user offer, publicly;
receiving a response to the second user offer by the first user; and
notifying other users that the at least one item is no longer available when the first user accepts the second user offer.

22. The non-transitory, computer readable medium of claim 21, further comprising instructions for requesting a shipping method from the first user and the second user for exchanging the traded items.

23. The non-transitory, computer readable medium of claim 21, further comprising instructions for notifying the second user of the first user rejection when the first user rejects the second user offer.

24. The non-transitory, computer readable medium of claim 21, further comprising instructions for:
receiving a counter offer from the first user in response to the offer for at least one item; and
transmitting the counter offer to the second user.

25. The non-transitory, computer readable medium of claim 21, further comprising instructions for requesting the first user and the second user to leave a feedback regarding the transaction.

26. The non-transitory, computer readable medium of claim 21, further comprising instructions for displaying a location of the first user for public view, the location associated with the at least one item.

27. The non-transitory, computer readable medium of claim 21, further comprising instructions for providing a map to each of the first user and the second user indicating the location of a third party storage location for the exchange of the first itern and the second item, the map also indicating a geo-location of at least the first user or the second user.

28. The non-transitory, computer readable medium of claim 21, further comprising instructions for providing a reminder to the first user and to the second user, when a shipping date for shipping the first item and the second item is due.

29. The non-transitory, computer readable medium of claim 27, further comprising instructions for providing security credentials to the first user and the second user to retrieve the items from the third party storage location.

30. The non-transitory, computer readable medium of claim 27, wherein the third party storage location cornprises a first storage location near the second user and a second storage location near the first user, further comprising instructions for:
receiving from the first storage location a first message when the first item from the first user has arrived; and
receiving from the second storage location a second message when the second item has arrived.

31. The non-transitory, computer readable medium of claim 30, further comprising instructions for:
sending the first message to the second storage location;
sending the second message to the first storage location;
upon receipt of the first message, instructing the second storage location to ship the second item to the first user; and
upon receipt of the second message, instructing the first storage location to ship the first item to the second user.

32. A computer device, comprising:
a memory circuit storing commands;
a networking circuit;
a processor circuit configured to execute the commands, causing the computer to perform the steps of:
providing a user of a mobile computer device access to a first user account;
receiving from the user a request to include an item in the first user account;
displaying the item for trade in a network of user accounts;
providing an offer for the item to the first user from a second user; and
notifying other users that the itern is no longer available when the first user accepts the offer from the second user.

33. The computer device of claim 32, further configured to perform the step of providing a counter offer from the first user to the second user.

34. The computer device of claim 32, further configured to perform the step of supporting the first user and the second user to ship exchanged terns to each other.

35. The computer device of claim 32, further configured to perform the step of receiving and storing feedback from the first and the second user about each other.

36. The computer device of claim 32, further configured to perform the step of communicating to a third user that the item for trade is no longer available.

37. The computer device of claim 32, further configured to perform the step of confirming a receipt of the item at a third party storage location,

38. The computer device of claim 32, further configured to perform the step of receiving through the networking circuit a geo-location for the first and the second users, and providing a map to the first and the second users displaying the geo-location of the first and the second users relative to a third party storage location that receives the traded items.

39. The computer device of claim 32, further configured to perform the step of providing security credentials to the first user and the second user to retrieve the exchanged items from a third party storage location.

40. The computer device of claim 32, further configured to perform the steps of:
receiving from the first user a feedback rating of the second user; and
receiving from the second user a feedback rating of the first user,
